(19) United States
(12) Patent Application Publication
(10) Pub. No.: US 2023/0289685 A1
(43) Pub. Date: Sep. 14, 2023

(54) OUT OF STOCK PRODUCT MISSED OPPORTUNITY

(71) Applicant: Content Square SAS, Paris (FR)

(72) Inventors: Raphaël Rose-Andrieux, Paris (FR); Daria Stefic, Paris (FR)

(21) Appl. No.: 17/694,223

(22) Filed: Mar. 14, 2022

(51) Int. Cl. G06Q 10/06; G06Q 30/02; G06Q 10/08

(52) U.S. Cl. CPC G06Q 10/06315; G06Q 30/0201; G06Q 10/087

(57) ABSTRACT

Systems and techniques may be used for providing a conversion loss insight. An example technique may include collecting pageviews for a plurality of users at a website, and identifying an out of stock item that appeared in a subset of the pageviews during a time period. The technique may include identifying, using a trained machine learning model, a similar product to the out of stock item, and determining whether the similar product was purchased in respective sessions corresponding to pageviews of the subset of pageviews. An insight may be output for display.

### BACKGROUND

Web commerce has become a nearly universal way to sell products. Managing web commerce websites is often done by a team of people, who use web analytics to make design, structural, and interactive choices for the web commerce websites. Sales data from a website may be used to determine whether a product is successful. However, the sales data does not tell the entire story, nor does it provide sufficient data to make proactive decisions.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some nonlimiting examples are illustrated in the figures of the accompanying drawings in which:

FIG. 1 is a diagrammatic representation of a networked environment in which the present disclosure may be deployed, in accordance with some examples.

FIG. 2 is a diagrammatic representation of an experience analytics system, in accordance with some examples, that has both client-side and server-side functionality.

FIG. 3 is a diagrammatic representation of a data structure as maintained in a database, in accordance with some examples.

FIG. 4 is a flowchart for a process, in accordance with some examples.

FIG. 5 is a diagrammatic representation of a machine in the form of a computer system within which a set of instructions may be executed for causing the machine to perform any one or more of the methodologies discussed herein, in accordance with some examples.

FIG. 6 is a block diagram showing a software architecture within which examples may be implemented.

FIG. 7 is an example user interface showing out of stock revenue loss in accordance with some examples.

FIG. 8 illustrates a block diagram for identifying a predicted category of similarity for products, in accordance with some examples.

FIG. 9 illustrates a machine learning engine for training and execution related to identifying similar products in accordance with at least one example of this disclosure.

### DETAILED DESCRIPTION

Systems and techniques described herein provide a conversion loss insight. When a user accesses a web page that includes an item for sale, the user may purchase the item. This may be referred to as a conversion. However, when the item is out of stock, the seller may not be able to convert the web page view to a sale. In cases where an item is out of stock (or listed as out of stock on the web page), the sale may be lost or delayed. The loss of the sale may not be easily tracked, due to the lack of conversion. In some examples where multiple items are displayed on a web page, the loss may be even more difficult to track. However, in some examples, a user may purchase another item, such as a similar item. In these examples, the sale is not necessarily lost to the seller, since another sale occurred.

The systems and techniques described herein provide a way to track and identify a modified conversion loss based on page views of an out of stock item, identification of a similar product to the out of stock item, and purchase information related to the similar product. In some examples, the item may be displayed with an out of stock icon to indicate that insights for the item are available for a web page owner or operator. The modified conversion loss may be displayed as a loss indicator, such as a number (e.g., a monetary value), which may be relative or absolute. The loss indicator may be qualitative, such as according to a color scheme, stars, etc. The modified conversion loss may be displayed as a conversion loss and a non-loss value, or as a single value representing the modified conversion loss.

In an example, the modified conversion loss may include using a price difference between the out of stock item and the similar product. In some examples, more than one similar product may be relevant and used to generate the modified conversion loss. A loss indicator corresponding to the modified conversion loss may be displayed (e.g., on a client device, the client including, for example, an owner or operator of a content page, such as for reviewing web analytics).

An example website may display an indication to a user that a current product or current selection (e.g., a variant) is out of stock. The out of stock item on the website may be displayed in a manner that differs from the how the item is displayed when in stock (e.g., faded, greyed out, dotted, partially transparent, etc.). A selectable purchase indication may be removed or un-selectable on the website when the item is out of stock. When a user visits the website, a pageview may be counted (e.g., one pageview per page or website). Pageviews for the out of stock item may be aggregated for users who view the out of stock item on the website (or elsewhere), to obtain a total pageview count of views of the out of stock item over a time period (e.g., during a session). Tracking of the out of stock item may occur while the item is out of stock over a time window, such as over a day, a week, a month, etc.

In some examples, an item may be in stock and out of stock over different portions of a time window. For example, the item may be out of stock on a first day, in stock days two to four, and out of stock again on day five. Over this five day time period, the item is out of stock two days and in stock three days. An out of stock revenue loss (and a modified conversion loss) may be calculated for the item based on the two out of stock days for the time window. A daily, weekly, hourly, etc. average modified conversion loss may be displayed in some examples (e.g., instead of or in addition to a total modified conversion loss over the time window). An item may be checked for whether it is out of stock against a stored product catalogue feed, which may be updated on a periodic basis, for example, every hour, every day, or the like.

After pageviews are aggregated, lost revenue may be calculated for an out of stock item. The lost revenue may be determined on a rolling or periodic basis, or may be determined on demand (e.g., when a user requests lost revenue information). The on demand determination may include using filtered data, such as according to a user specification. A machine learning trained model may be used (before or after the pageviews are aggregated or the lost revenue is calculated) to identify a similar product. Replacement revenue related to sales of the similar product during sessions where lost revenue was calculated for the out of stock item may be determined. The replacement revenue may be used to offset the lost revenue to determine a modified lost revenue.

In an example, a client website (e.g., for displaying an insight to an owner or operator of a user website) may be used to filter results of out of stock products for modified revenue loss. Filtering (or searching) may be done based on a variety of features of products, revenue loss, modified revenue loss, or the like. For example, a client may filter results of out of stock products with modified revenue loss based on thresholds (e.g., minimum, maximum, a range, etc.) for revenue loss, modified revenue loss, conversion rate, pageviews, or the like. A client may filter based on product attributes, such as size, color, etc. In some examples, a client may filter based on an attribute of a user corresponding to a pageview (e.g., a user who viewed the out of stock product). In these examples, the filtering may be done based on customer loyalty status (e.g., show only users who have a loyalty status), login status (e.g., show only users who were logged into the site when accessing an out of stock product), previous purchasers (e.g., users who have previously purchased something from the website, or who have purchased the out of stock product), source of pageview (e.g., via a media campaign, such as an email link, an ad on a search engine, a direct link, a selection of a link from a landing page or home page, etc.), or the like.

The client website may be used to filter results that were already calculated in an example. In another example, the client website may be used to pre-filter and generate new results based on the pre-filtering. Other types of filtering or searching may use the client website to generate or display results. For example, a client may select a custom time period (e.g., last X number of hours, days, weeks, etc.) for one or more products. Relevant results for modified revenue lost corresponding to out of stock products in that custom time period may be displayed (and optionally further filtered or pre-filtered). The modified lost revenue may correspond to times when the product was out of stock during the custom time period, although the product may also have been in stock during certain portions of the custom time period.

The client website may be used to display information corresponding to a modified revenue loss. For example, out of stock items may be ranked according to the modified revenue loss, and displayed according to the ranking. The ranking may include highest modified revenue loss over a time period, highest conversion rate corresponding to an out of stock item during a time period, most pageviews of an out of stock item during a time period, etc. The ranking may be customized by a client, such as including only filtered results (e.g., as described above), using a custom time frame, items with a modified lost revenue, conversion rate, or pageview count traversing a particular threshold (e.g., a minimum, a maximum, or a range), or the like. A product may be displayed with a sensitivity score, for example according to how close the product's modified revenue loss is to zero or to an unmodified revenue loss for the product. For example, when revenue for an out of stock product is replaced to a large degree by a similar product, the product may have a low sensitivity score (e.g., the out of stock product is highly replaceable, and having it out of stock leads to little or no revenue loss). Or, when revenue for an out of stock product is hardly or not at all replaced by a similar product, the product may have a high sensitivity score (e.g., the out of stock product is not easily replaceable, and having it out of stock leads to a relatively large revenue loss).

Networked Computing Environment

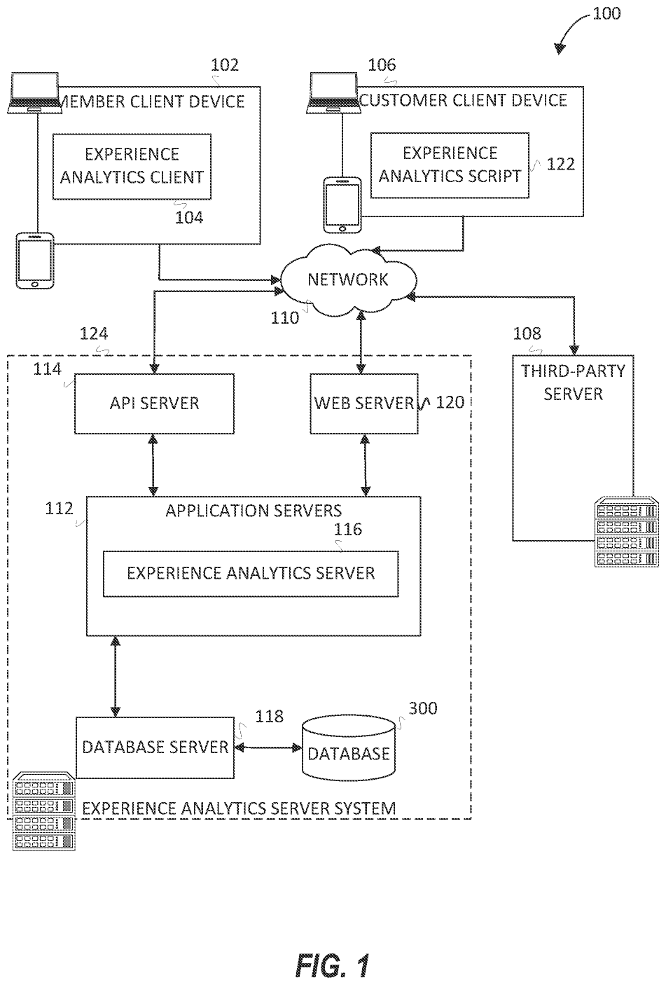

FIG. 1 is a block diagram showing an example experience analytics system 100 that analyzes and quantifies the user experience of users navigating a client's website, mobile websites, and applications. The experience analytics system 100 can include multiple instances of a member client device 102, multiple instances of a customer client device 106, and multiple instances of a third-party server 108.

The member client device 102 is associated with a client of the experience analytics system 100, where the client that has a website hosted on the client's third-party server 108. For example, the client can be a retail store that has an online retail website that is hosted on a third-party server 108. An agent of the client (e.g., a web administrator, an employee, etc.) can be the user of the member client device 102.

Each of the member client devices 102 hosts a number of applications, including an experience analytics client 104. Each experience analytics client 104 is communicatively coupled with an experience analytics server system 124 and third-party servers 108 via a network 110 (e.g., the Internet). An experience analytics client 104 can also communicate with locally-hosted applications using Applications Program Interfaces (APIs).

The member client devices 102 and the customer client devices 106 can also host a number of applications including Internet browsing applications (e.g., Chrome, Safari, etc.). The experience analytics client 104 can also be implemented as a platform that is accessed by the member client device 102 via an Internet browsing application or implemented as an extension on the Internet browsing application.

Users of the customer client device 106 can access client's websites that are hosted on the third-party servers 108 via the network 110 using the Internet browsing applications. For example, the users of the customer client device 106 can navigate to a client's online retail website to purchase goods or services from the website. While the user of the customer client device 106 is navigating the client's website on an Internet browsing application, the Internet browsing application on the customer client device 106 can also execute a client-side script (e.g., JavaScript (.*js)) such as an experience analytics script 122. In one example, the experience analytics script 122 is hosted on the third-party server 108 with the client's website and processed by the Internet browsing application on the customer client device 106. The experience analytics script 122 can incorporate a scripting language (e.g., a .*js file or a .json file).

In certain examples, a client's native application (e.g., ANDROID™ or IOS™ Application) is downloaded on the customer client device 106. In this example, the client's native application including the experience analytics script 122 is programmed in JavaScript leveraging a Software Development Kit (SDK) provided by the experience analytics server system 124. The SDK includes Application Programming Interfaces (APIs) with functions that can be called or invoked by the client's native application.

In one example, the experience analytics script 122 records data including the changes in the interface of the website being displayed on the customer client device 106, the elements on the website being displayed or visible on the interface of the customer client device 106, the text inputs by the user into the website, a movement of a mouse (or touchpad or touch screen) cursor and mouse (or touchpad or touch screen) clicks on the interface of the website, etc. The experience analytics script 122 transmits the data to experience analytics server system 124 via the network 110. In another example, the experience analytics script 122 transmits the data to the third-party server 108 and the data can be transmitted from the third-party server 108 to the experience analytics server system 124 via the network 110.

An experience analytics client 104 is able to communicate and exchange data with the experience analytics server system 124 via the network 110. The data exchanged between the experience analytics client 104 and the experience analytics server system 124, includes functions (e.g., commands to invoke functions) as well as payload data (e.g., website data, texts reporting errors, insights, merchandising information, adaptability information, images, graphs providing visualizations of experience analytics, session replay videos, zoning and overlays to be applied on the website, etc.).

The experience analytics server system 124 supports various services and operations that are provided to the experience analytics client 104. Such operations include transmitting data to and receiving data from the experience analytics client 104. Data exchanges to and from the experience analytics server system 124 are invoked and controlled through functions available via user interfaces (UIs) of the experience analytics client 104.

The experience analytics server system 124 provides server-side functionality via the network 110 to a particular experience analytics client 104. While certain functions of the experience analytics system 100 are described herein as being performed by either an experience analytics client 104 or by the experience analytics server system 124, the location of certain functionality either within the experience analytics client 104 or the experience analytics server system 124 may be a design choice. For example, it may be technically preferable to initially deploy certain technology and functionality within the experience analytics server system 124 but to later migrate this technology and functionality to the experience analytics client 104 where a member client device 102 has sufficient processing capacity.

Turning now specifically to the experience analytics server system 124, an Application Program Interface (API) server 114 is coupled to, and provides a programmatic interface to, application servers 112. The application servers 112 are communicatively coupled to a database server 118, which facilitates access to a database 300 that stores data associated with experience analytics processed by the application servers 112. Similarly, a web server 120 is coupled to the application servers 112, and provides web-based interfaces to the application servers 112. To this end, the web server 120 processes incoming network requests over the Hypertext Transfer Protocol (HTTP) and several other related protocols.

The Application Program Interface (API) server 114 receives and transmits message data (e.g., commands and message payloads) between the member client device 102 and the application servers 112. Specifically, the Application Program Interface (API) server 114 provides a set of interfaces (e.g., routines and protocols) that can be called or queried by the experience analytics client 104 or the experience analytics script 122 in order to invoke functionality of the application servers 112. The Application Program Interface (API) server 114 exposes to the experience analytics client 104 various functions supported by the application servers 112, including generating information on errors, insights, merchandising information, adaptability information, images, graphs providing visualizations of experience analytics, session replay videos, zoning and overlays to be applied on the website, etc.

The application servers 112 host a number of server applications and subsystems, including for example an experience analytics server 116. The experience analytics server 116 implements a number of data processing technologies and functions, particularly related to the aggregation and other processing of data including the changes in the interface of the website being displayed on the customer client device 106, the elements on the website being displayed or visible on the interface of the customer client device 106, the text inputs by the user into the website, a movement of a mouse (or touchpad) cursor and mouse (or touchpad) clicks on the interface of the website, etc. received from multiple instances of the experience analytics script 122 on customer client devices 106. The experience analytics server 116 implements processing technologies and functions, related to generating user interfaces including information on errors, insights, merchandising information, adaptability information, images, graphs providing visualizations of experience analytics, session replay videos, zoning and overlays to be applied on the website, etc. Other processor and memory intensive processing of data may also be performed server-side by the experience analytics server 116, in view of the hardware requirements for such processing.

### System Architecture

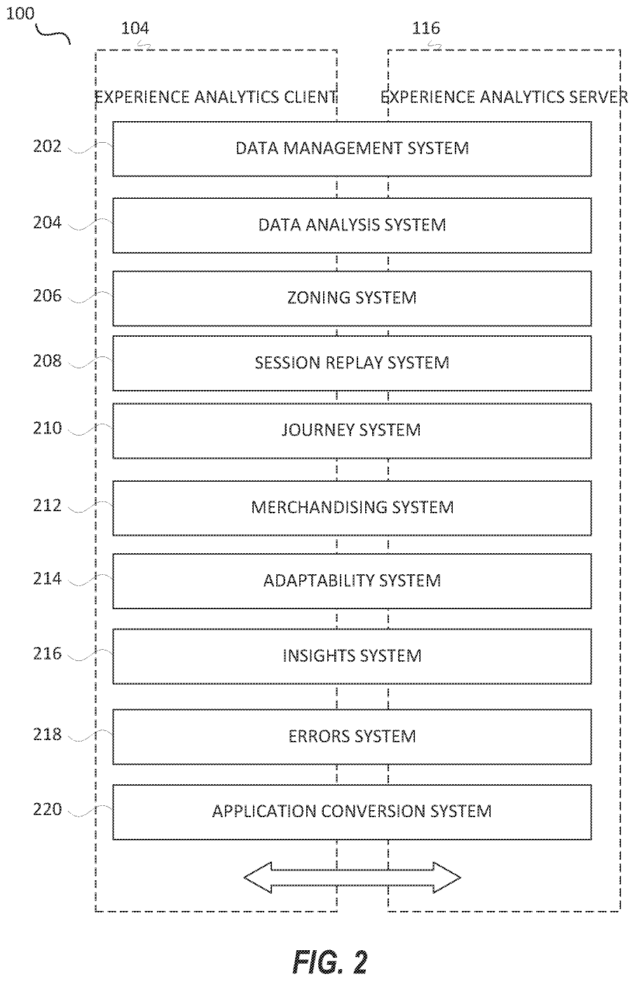

FIG. 2 is a block diagram illustrating further details regarding the experience analytics system 100 according to some examples. Specifically, the experience analytics system 100 is shown to comprise the experience analytics client 104 and the experience analytics server 116. The experience analytics system 100 embodies a number of subsystems, which are supported on the client-side by the experience analytics client 104 and on the server-side by the experience analytics server 116. These subsystems include, for example, a data management system 202, a data analysis system 204, a zoning system 206, a session replay system 208, a journey system 210, a merchandising system 212, an adaptability system 214, an insights system 216, an errors system 218, and an application conversion system 220.

The data management system 202 is responsible for receiving functions or data from the member client devices 102, the experience analytics script 122 executed by each of the customer client devices 106, and the third-party servers 108. The data management system 202 is also responsible for exporting data to the member client devices 102 or the third-party servers 108 or between the systems in the experience analytics system 100. The data management system 202 is also configured to manage the third-party integration of the functionalities of experience analytics system 100.

The data analysis system 204 is responsible for analyzing the data received by the data management system 202, generating data tags, performing data science and data engineering processes on the data.

The zoning system 206 is responsible for generating a zoning interface to be displayed by the member client device 102 via the experience analytics client 104. The zoning interface provides a visualization of how the users via the customer client devices 106 interact with each element on the client's website. The zoning interface can also provide an aggregated view of in-page behaviors by the users via the customer client device 106 (e.g., clicks, scrolls, navigation). The zoning interface can also provide a side-by-side view of different versions of the client's website for the client's analysis. For example, the zoning system 206 can identify the zones in a client's website that are associated with a particular element in displayed on the website (e.g., an icon, a text link, etc.). Each zone can be a portion of the website being displayed. The zoning interface can include a view of the client's website. The zoning system 206 can generate an overlay including data pertaining to each of the zones to be overlaid on the view of the client's website. The data in the overlay can include, for example, the number of views or clicks associated with each zone of the client's website within a period of time, which can be established by the user of the member client device 102. In one example, the data can be generated using information from the data analysis system 204.

The session replay system 208 is responsible for generating the session replay interface to be displayed by the member client device 102 via the experience analytics client 104. The session replay interface includes a session replay that is a video reconstructing an individual user's session (e.g., visitor session) on the client's website. The user's session starts when the user arrives at the client's website and ends upon the user's exit from the client's website. A user's session when visiting the client's website on a customer client device 106 can be reconstructed from the data received from the user's experience analytics script 122 on customer client devices 106. The session replay interface can also include the session replays of a number of different visitor sessions to the client's website within a period of time (e.g., a week, a month, a quarter, etc.). The session replay interface allows the client via the member client device 102 to select and view each of the session replays. In one example, the session replay interface can also include an identification of events (e.g., failed conversions, angry customers, errors in the website, recommendations or insights) that are displayed and allow the user to navigate to the part in the session replay corresponding to the events such that the client can view and analyze the event.

The journey system 210 is responsible for generating the journey interface to be displayed by the member client device 102 via the experience analytics client 104. The journey interface includes a visualization of how the visitors progress through the client's website, page-by-page, from entry onto the website to the exit (e.g., in a session). The journey interface can include a visualization that provides a customer journey mapping (e.g., sunburst visualization). This visualization aggregates the data from all of the visitors (e.g., users on different customer client devices 106) to the website, and illustrates the visited pages and in order in which the pages were visited. The client viewing the journey interface on the member client device 102 can identify anomalies such as looping behaviors and unexpected drop-offs. The client viewing the journey interface can also assess the reverse journeys (e.g., pages visitors viewed before arriving at a particular page). The journey interface also allows the client to select a specific segment of the visitors to be displayed in the visualization of the customer journey.

The merchandising system 212 is responsible for generating the merchandising interface to be displayed by the member client device 102 via the experience analytics client 104. The merchandising interface includes merchandising analysis that provides the client with analytics on the merchandise to be promoted on the website, optimization of sales performance, the items in the client's product catalog on a granular level, competitor pricing, etc. The merchandising interface can, for example, comprise graphical data visualization pertaining to product opportunities, category, brand performance, etc. For instance, the merchandising interface can include the analytics on conversions (e.g., sales, revenue) associated with a placement or zone in the client website.

The adaptability system 214 is responsible for creating accessible digital experiences for the client's website to be displayed by the customer client devices 106 for users that would benefit from an accessibility-enhanced version of the client's website. For instance, the adaptability system 214 can improve the digital experience for users with disabilities, such as visual impairments, cognitive disorders, dyslexia, and age-related needs. The adaptability system 214 can, with proper user permissions, analyze the data from the experience analytics script 122 to determine whether an accessibility-enhanced version of the client's website is needed, and can generate the accessibility-enhanced version of the client's website to be displayed by the customer client device 106.

The insights system 216 is responsible for analyzing the data from the data management system 202 and the data analysis system 204 surface insights that include opportunities as well as issues that are related to the client's website. The insights can also include alerts that notify the client of deviations from a client's normal business metrics. The insights can be displayed by the member client devices 102 via the experience analytics client 104 on a dashboard of a user interface, as a pop-up element, as a separate panel, etc. In this example, the insights system 216 is responsible for generating an insights interface to be displayed by the member client device 102 via the experience analytics client 104. In another example, the insights can be incorporated in another interface such as the zoning interface, the session replay, the journey interface, or the merchandising interface to be displayed by the member client device 102.

The errors system 218 is responsible for analyzing the data from the data management system 202 and the data analysis system 204 to identify errors that are affecting the visitors to the client's website and the impact of the errors on the client's business (e.g., revenue loss). The errors can include the location within the user journey on the website and the page that adversely affects (e.g., causes frustration for) the users (e.g., users on customer client devices 106 visiting the client's website). The errors can also include causes of looping behaviors by the users, in-page issues such as unresponsive calls to action and slow loading pages, etc. The errors can be displayed by the member client devices 102 via the experience analytics client 104 on a dashboard of a user interface, as a pop-up element, as a separate panel, etc. In this example, the errors system 218 is responsible for generating an errors interface to be displayed by the member client device 102 via the experience analytics client 104. In another example, the insights can be incorporated in another interface such as the zoning interface, the session replay, the journey interface, or the merchandising interface to be displayed by the member client device 102.

The application conversion system 220 is responsible for the conversion of the functionalities of the experience analytics server 116 as provided to a client's website to a client's native mobile applications. For instance, the application conversion system 220 generates the mobile application version of the zoning interface, the session replay, the journey interface, the merchandising interface, the insights interface, and the errors interface to be displayed by the member client device 102 via the experience analytics client 104. The application conversion system 220 generates an accessibility-enhanced version of the client's mobile application to be displayed by the customer client devices 106.

The data management system 202 may store pageviews or unit prices corresponding to out of stock items. The data analysis system 204 may use the stored pageviews or unit prices, for example along with an average conversion rate, to determine a loss indicator for the out of stock item. The average conversion rate may be stored at the data management system 202. The loss indicator may be output from the experience analytics server 116, for example to a user device for display.

### Data Architecture

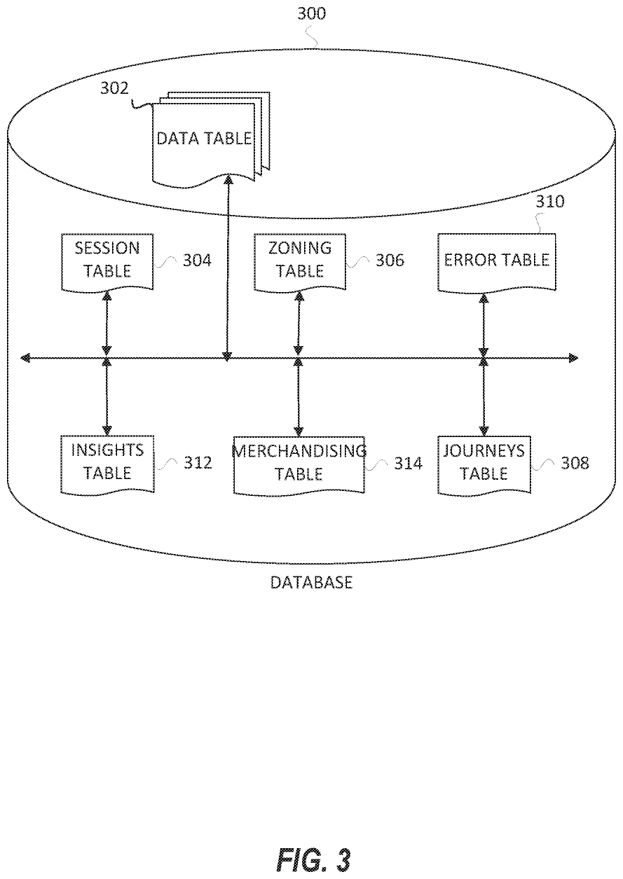

FIG. 3 is a schematic diagram illustrating database 300, which may be stored in the database 300 of the experience analytics server 116, according to certain examples. While the content of the database 300 is shown to comprise a number of tables, it will be appreciated that the data could be stored in other types of data structures (e.g., as an object-oriented database).

The database 300 includes a data table 302, a session table 304, a zoning table 306, an error table 310, an insights table 312, a merchandising table 314, and a journeys table 308.

The data table 302 stores data regarding the websites and native applications associated with the clients of the experience analytics system 100. The data table 302 can store information on the contents of the website or the native application, the changes in the interface of the website being displayed on the customer client device 106, the elements on the website being displayed or visible on the interface of the customer client device 106, the text inputs by the user into the website, a movement of a mouse (or touchpad or touch screen) cursor and mouse (or touchpad or touch screen) clicks on the interface of the website, etc. The data table 302 can also store data tags and results of data science and data engineering processes on the data. The data table 302 can also store information such as the font, the images, the videos, the native scripts in the website or applications, etc.

The session table 304 stores session replays for each of the client's websites and native applications.

The zoning table 306 stores data related to the zoning for each of the client's websites and native applications including the zones to be created and the zoning overlay associated with the websites and native applications.

The journeys table 308 stores data related to the journey of each visitor to the client's website or through the native application.

The error table 310 stores data related to the errors generated by the errors system 218 and the insights table 312 stores data related to the insights generated by the insights table 312.

The merchandising table 314 stores data associated with the merchandising system 212. For example, the data in the merchandising table 314 can include the product catalog for each of the clients, information on the competitors of each of the clients, the data associated with the products on the websites and applications, the analytics on the product opportunities and the performance of the products based on the zones in the website or application, etc.

### Process

Although the described flowcharts can show operations as a sequential process, many of the operations can be performed in parallel or concurrently. In addition, the order of the operations may be re-arranged. A process is terminated when its operations are completed. A process may correspond to a method, a procedure, an algorithm, etc. The operations of methods may be performed in whole or in part, may be performed in conjunction with some or all of the operations in other methods, and may be performed by any number of different systems, such as the systems described herein, or any portion thereof, such as a processor included in any of the systems.

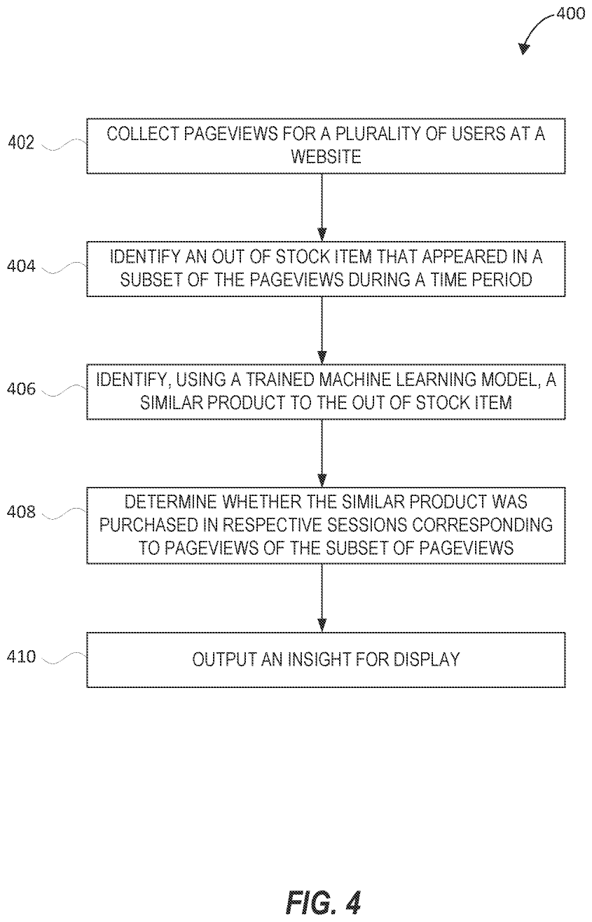

FIG. 4 is a schematic diagram illustrating a process 400, for providing a conversion loss insight. The conversion loss insight may include a correction to an out of stock revenue loss based on a conversion rate for a similar product.

The process 400 includes an operation 402 to collect pageviews for a plurality of users at a website. The process 400 includes an operation 404 to identify an out of stock item that appeared in a subset of the pageviews during a time period.

The process 400 includes an operation 406 to identify, using a trained machine learning model, a similar product to the out of stock item. Operation 406 may include identifying, using the trained machine learning model, a plurality of similar products to the out of stock item. In this example, the insight may include information corresponding to a number of the respective sessions where any of the plurality of similar products were purchased. The trained machine learning model may be trained using one or more of product titles, product categories, product brands, product descriptions, product reviews, product images, or the like. In some examples, the trained machine learning model is trained based on user interactions in training sessions, such as including one or more of sequences of products added to a card, sequences of product views, transactions, or the like. In an example, operation 406 may include identifying the similar product using a distance calculation between an embedding corresponding to the out of stock item and an embedding corresponding to a prospective similar product. The distance calculation may include using a k nearest neighbor technique, a Euclidean distance formula, etc.

The process 400 includes an operation 408 to determine whether the similar product was purchased in respective sessions corresponding to pageviews of the subset of pageviews. The process 400 includes an operation 410 to output an insight for display. In an example, the insight including information corresponding to a number of the respective sessions where the similar product was purchased. Operation 410 may include outputting a sensitivity score. The sensitivity score may identify a likelihood of the similar product being purchased when the out of stock item is out of stock.

The process 400 may include an operation to determine a loss indicator corresponding to lost revenue due to the out of stock item, for example based on the subset of pageviews, a unit price, and a conversion rate corresponding to the out of stock item during the time period. The unit price and the conversion rate may be retrieved or generated (e.g., from storage, or calculated). The insight in this example may include information corresponding to the lost revenue. For example, the insight may include a modified lost revenue based on a difference between the lost revenue and revenue generated from the respective sessions where the similar product was purchased. In an example, the modified lost revenue may include an adjustment for a price difference between the out of stock item and the similar product.

### Machine Architecture

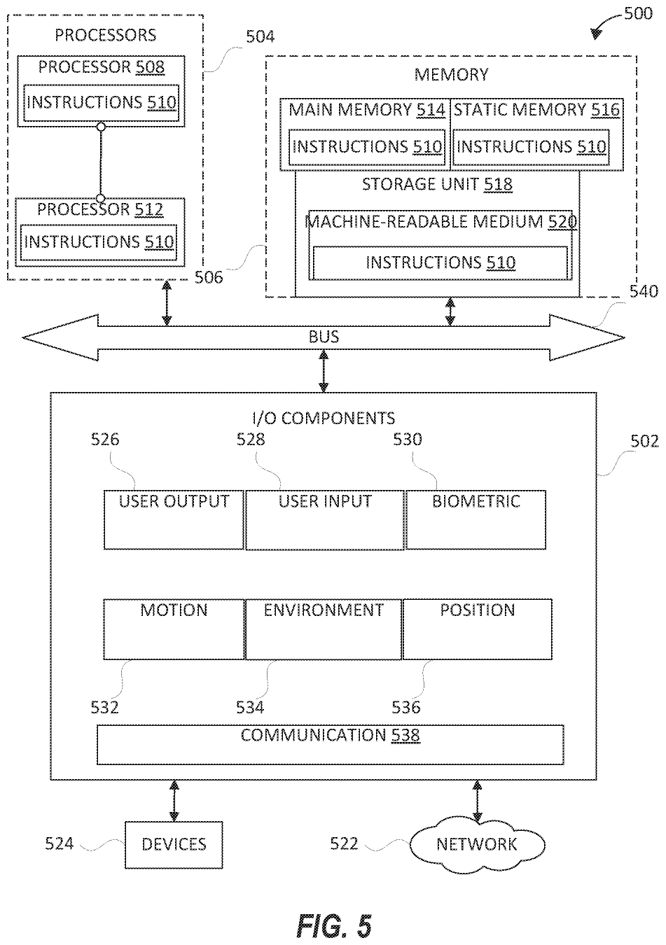

FIG. 5 is a diagrammatic representation of the machine 500 within which instructions 510 (e.g., software, a program, an application, an applet, an application, or other executable code) for causing the machine 500 to perform any one or more of the methodologies discussed herein may be executed. For example, the instructions 510 may cause the machine 500 to execute any one or more of the methods described herein. The instructions 510 transform the general, non-programmed machine 500 into a particular machine 500 programmed to carry out the described and illustrated functions in the manner described. The machine 500 may operate as a standalone device or may be coupled (e.g., networked) to other machines. In a networked deployment, the machine 500 may operate in the capacity of a server machine or a client machine in a server-client network environment, or as a peer machine in a peer-to-peer (or distributed) network environment. The machine 500 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 510, sequentially or otherwise, that specify actions to be taken by the machine 500. Further, while only a single machine 500 is illustrated, the term “machine” shall also be taken to include a collection of machines that individually or jointly execute the instructions 510 to perform any one or more of the methodologies discussed herein. The machine 500, for example, may comprise the member client device 102 or any one of a number of server devices forming part of the experience analytics server 116. In some examples, the machine 500 may also comprise both client and server systems, with certain operations of a particular method or algorithm being performed on the server-side and with certain operations of the particular method or algorithm being performed on the client-side.

The machine 500 may include processors 504, memory 506, and input/output I/O components 502, which may be configured to communicate with each other via a bus 540. In an example, the processors 504 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 508 and a processor 512 that execute the instructions 510. The term “processor” is intended to include multi-core processors that may comprise two or more independent processors (sometimes referred to as “cores”) that may execute instructions contemporaneously. Although FIG. 5 shows multiple processors 504, the machine 500 may include a single processor with a single-core, a single processor with multiple cores (e.g., a multi-core processor), multiple processors with a single core, multiple processors with multiples cores, or any combination thereof.

The memory 506 includes a main memory 514, a static memory 516, and a storage unit 518, both accessible to the processors 504 via the bus 540. The main memory 506, the static memory 516, and storage unit 518 store the instructions 510 embodying any one or more of the methodologies or functions described herein. The instructions 510 may also reside, completely or partially, within the main memory 514, within the static memory 516, within machine-readable medium 520 within the storage unit 518, within at least one of the processors 504 (e.g., within the processor's cache memory), or any suitable combination thereof, during execution thereof by the machine 500.

The I/O components 502 may include a wide variety of components to receive input, provide output, produce output, transmit information, exchange information, capture measurements, and so on. The specific I/O components 502 that are included in a particular machine will depend on the type of machine. For example, portable machines such as mobile phones may include a touch input device or other such input mechanisms, while a headless server machine will likely not include such a touch input device. It will be appreciated that the I/O components 502 may include many other components that are not shown in FIG. 5. In various examples, the I/O components 502 may include user output components 526 and user input components 528. The user output components 526 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 528 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 502 may include biometric components 530, motion components 532, environmental components 534, or position components 536, among a wide array of other components. For example, the biometric components 530 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The motion components 532 include acceleration sensor components (e.g., accelerometer), gravitation sensor components, rotation sensor components (e.g., gyroscope).

The environmental components 534 include, for example, one or cameras (with still image/photograph and video capabilities), illumination sensor components (e.g., photometer), temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the member client device 102 may have a camera system comprising, for example, front cameras on a front surface of the member client device 102 and rear cameras on a rear surface of the member client device 102. The front cameras may, for example, be used to capture still images and video of a user of the member client device 102 (e.g., “selfies”). The rear cameras may, for example, be used to capture still images and videos in a more traditional camera mode. In addition to front and rear cameras, the member client device 102 may also include a 3600 camera for capturing 3600 photographs and videos.

Further, the camera system of a member client device 102 may include dual rear cameras (e.g., a primary camera as well as a depth-sensing camera), or even triple, quad or penta rear camera configurations on the front and rear sides of the member client device 102. These multiple cameras systems may include a wide camera, an ultra-wide camera, a telephoto camera, a macro camera and a depth sensor, for example.

The position components 536 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 502 further include communication components 538 operable to couple the machine 500 to a network 522 or devices 524 via respective coupling or connections. For example, the communication components 538 may include a network interface component or another suitable device to interface with the network 522. In further examples, the communication components 538 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 524 may be another machine or any of a wide variety of peripheral devices (e.g., a peripheral device coupled via a USB).

Moreover, the communication components 538 may detect identifiers or include components operable to detect identifiers. For example, the communication components 538 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph, MaxiCode, PDF417, Ultra Code, UCC RSS-2D bar code, and other optical codes), or acoustic detection components (e.g., microphones to identify tagged audio signals). In addition, a variety of information may be derived via the communication components 538, such as location via Internet Protocol (IP) geolocation, location via Wi-Fi® signal triangulation, location via detecting an NFC beacon signal that may indicate a particular location, and so forth.

The various memories (e.g., main memory 514, static memory 516, and memory of the processors 504) and storage unit 518 may store one or more sets of instructions and data structures (e.g., software) embodying or used by any one or more of the methodologies or functions described herein. These instructions (e.g., the instructions 510), when executed by processors 504, cause various operations to implement the disclosed examples.

The instructions 510 may be transmitted or received over the network 522, using a transmission medium, via a network interface device (e.g., a network interface component included in the communication components 538) and using any one of several well-known transfer protocols (e.g., hypertext transfer protocol (HTTP)). Similarly, the instructions 510 may be transmitted or received using a transmission medium via a coupling (e.g., a peer-to-peer coupling) to the devices 524.

### Software Architecture

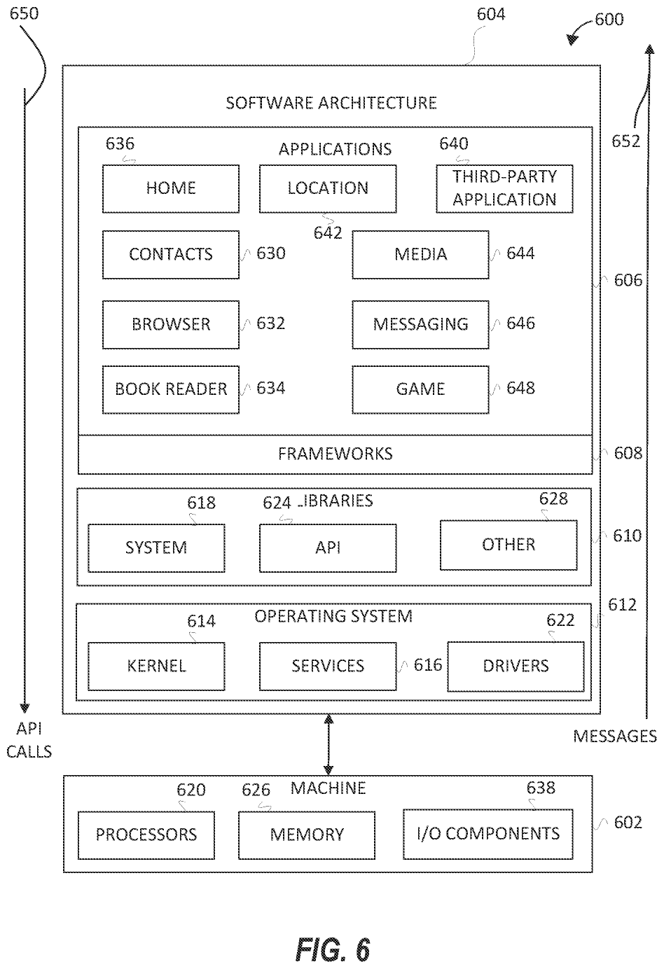

FIG. 6 is a block diagram 600 illustrating a software architecture 604, which can be installed on any one or more of the devices described herein. The software architecture 604 is supported by hardware such as a machine 602 that includes processors 620, memory 626, and I/O components 638. In this example, the software architecture 604 can be conceptualized as a stack of layers, where each layer provides a particular functionality. The software architecture 604 includes layers such as an operating system 612, libraries 610, frameworks 608, and applications 606. Operationally, the applications 606 invoke API calls 650 through the software stack and receive messages 652 in response to the API calls 650.

The operating system 612 manages hardware resources and provides common services. The operating system 612 includes, for example, a kernel 614, services 616, and drivers 622. The kernel 614 acts as an abstraction layer between the hardware and the other software layers. For example, the kernel 614 provides memory management, processor management (e.g., scheduling), component management, networking, and security settings, among other functionalities. The services 616 can provide other common services for the other software layers. The drivers 622 are responsible for controlling or interfacing with the underlying hardware. For instance, the drivers 622 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 610 provide a common low-level infrastructure used by the applications 606. The libraries 610 can include system libraries 618 (e.g., C standard library) that provide functions such as memory allocation functions, string manipulation functions, mathematic functions, and the like. In addition, the libraries 610 can include API libraries 624 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 610 can also include a wide variety of other libraries 628 to provide many other APIs to the applications 606.

The frameworks 608 provide a common high-level infrastructure that is used by the applications 606. For example, the frameworks 608 provide various graphical user interface (GUI) functions, high-level resource management, and high-level location services. The frameworks 608 can provide a broad spectrum of other APIs that can be used by the applications 606, some of which may be specific to a particular operating system or platform.

In an example, the applications 606 may include a home application 636, a contacts application 630, a browser application 632, a book reader application 634, a location application 642, a media application 644, a messaging application 646, a game application 648, and a broad assortment of other applications such as a third-party application 640. The applications 606 are programs that execute functions defined in the programs. Various programming languages can be employed to create one or more of the applications 606, structured in a variety of manners, such as object-oriented programming languages (e.g., Objective-C, Java, or C++) or procedural programming languages (e.g., C or assembly language). In a specific example, the third-party application 640 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 640 can invoke the API calls 650 provided by the operating system 612 to facilitate functionality described herein.

### User Interfaces

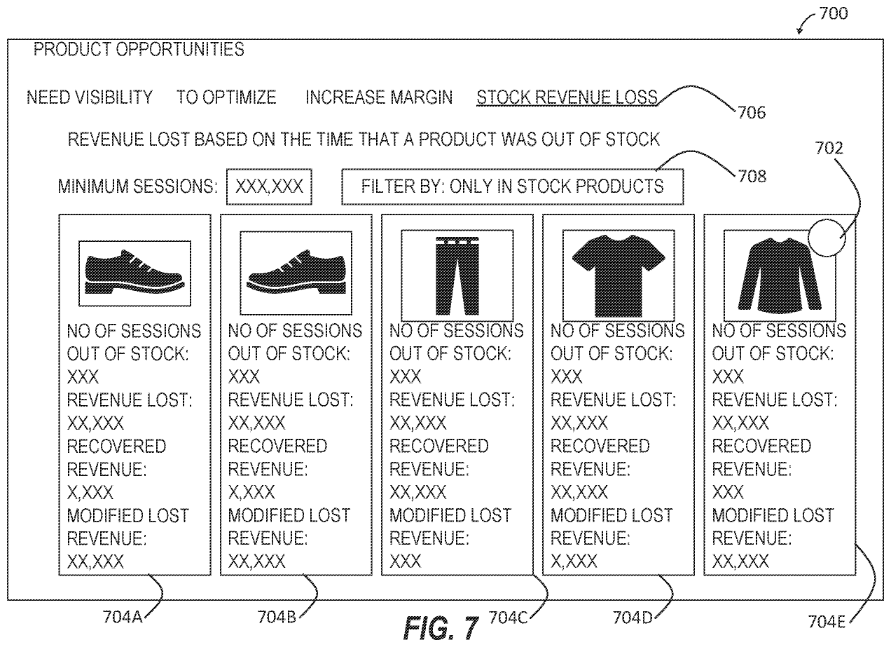

FIG. 7 illustrates an example client interface 700. The client interface 700 illustrates various products (e.g., a shoe, a t-shirt, etc.). One item in the client interface 700 is currently listed as out of stock, the shirt. To signify this status, the client interface 700 includes an indication 702, which may be differentiated in some examples with a color (e.g., red) to draw visual attention to the indication 702. The indication 702 may be sized in some examples, such as to show how long the item has been out of stock or how large a revenue loss or modified revenue loss occurred or is occurring due to the item being out of stock. The indication 702 may be selectable, such as to view further detail or breakdown information related to the revenue loss or the modified revenue loss.

In an example, the client interface 700 may correspond to a merchandising analytics web page, app page, or other user interface. The client interface 700 indicates when a product is out of stock, identifies an amount of revenue lost because of the out of stock situation, or identifies a modified revenue loss due to an out of stock item and a similar purchased product. Products that are out of stock may be identified or displayed based on impact of the out of stock products by category or brands. In some examples, products or categories of products may be ranked by modified revenue loss or sensitivity (e.g., restocking a particular item, such as the shoes may provide a significant benefit). When information regarding stock availability is provided by a client, such as a web page owner or operator, the client interface 700, including availability of the product, may be displayed (e.g., amount of stock available or available/not available). In an example, some values of stock may include: “in stock”, “yes”, “y”, “true”, “1”, “out of stock”, “no”, “n”, “false”, “0,” or values indicating number of items in stock. When a number in stock is shown, products may be filtered with a quantity range.

The client interface 700 includes insights for each of the items that were out of stock, for example during a time period. The client interface 700 includes five example products, with insights shown in components 704A-E. The components 704A-E show various optional insights (which may vary by client preference, by product, by result, etc.). The insights shown by way of example in the components 704A-E include a number of sessions where a corresponding product was out of stock, a revenue lost based on a number of sessions out of stock for the product, a recovered revenue (e.g., based on sales during corresponding sessions of a similar product to the out of stock product), or a modified lost revenue. The sessions may correspond to a user interaction with a website with one or more pageviews during a time period (e.g., from when a website is initially visited until the website (or a related website) is closed or reloaded, or when a timeout occurs). The sessions displayed may indicate a number of sessions with at least one pageview of a product page when the product was out of stock. The revenue lost may correspond to the sessions, a unit price during each of the sessions (which may be the same in some examples), and an average conversion rate. The average conversion rate may correspond to the item (e.g., based on historical conversion rates for the item or a current conversion rate), to a category of the item (e.g., shoes, shirts, books, etc., which may be further divided into categories such as athletic shoes or dress shoes, science fiction books or romance books, or the like), to a particular web store or page, or the like.

The modified lost revenue shown in the components 704A-E may be equal to the revenue lost minus the recovered revenue for each product. Recovered revenue may correspond to revenue from a similar product or a similar set of products that were purchased during sessions where the product was out of stock. The revenue lost may include a number of visits when the item was out of stock multiplied by a unit price at the time of the visits multiplied by an average conversion rate of the category during a time period (e.g., a week). In an example, products taken into account in the category conversion rate may be chosen using catalog data provided by the customer or a product similarity model. The average conversion rate may be taken on a daily, weekly, monthly, or other time period basis. In an example, a conversion rate may be generated on a daily, weekly, monthly, or other time period basis. For example, for an eight day period, the conversion rate may include eight separate conversion rates (e.g., one per day), two conversion rates (e.g., one for a first week and one for a second week), one conversion rate (e.g., monthly), or an average conversion rate (e.g., based on eight daily, two weekly, or based on some other time period), or the like. When an analysis context timeframe differs from the average conversion rate time period (e.g., ten days), the conversion rate (CR) may be an average of the CR of a first week (e.g., seven days) and of the CR of a second week (e.g., three days). In some examples, the average may be a weighted average (e.g., weighted seven to three in favor of the first week over the second week).

The modified lost revenue may include an adjustment for a price difference between the product that was out of stock and the similar product that was purchased. For example, the recovered revenue may correspond to a similar product to the out of stock product, where the similar product has a higher revenue (e.g., higher price) than the out of stock product. In this example with the similar product having a higher revenue, the “loss” on the revenue of replacing the out of stock product with the similar product is negative, meaning that the seller is better off having the out of stock product be out of stock, at least for those sessions where the similar product was purchased. To illustrate the price differential, a number of times a similar product was sold per session where the out of stock product was viewed may be displayed as an insight. This insight may be compared to a conversion rate of the out of stock product to evaluate whether a lower or higher conversion rate or a lower or higher price contributed to the modified lost revenue.

The client interface 700 may be displayed in response to a user selection of a “stock revenue loss” indicator 706. Results may be displayed in the client interface 700, the results based on a determination of at least one product that represented lost revenue due to being out of stock. In some cases, a product may have zero similar products or zero same-session purchases of a similar product. In these examples, the revenue lost may equal the modified lost revenue, while the recovered revenue may be zero.

A user may filter or search for results, for example based on time period (e.g., over calendar dates), or time a product was out of stock (e.g., all products out of stock for at least a week), based on product status (e.g., products now in stock), based on sales data (e.g., products with sales since being out of stock or sales before being out of stock, such as a minimum number or amount of sales), type of product, etc. A filter component 708 may be used to filter or search by product type, for example. Other filter or search options may include using a threshold (e.g., minimum, maximum, range, etc.) number of sessions (e.g., pageviews of an out of stock item), threshold revenue loss, threshold conversion rate, or the like. In an example, the filter may include options to show only active products, only in stock products, or only out of stock products.

The components 704A-E represent a few example situations where insights may be useful for a client analyzing out of stock products. For example, the shoes represented by the components 704A-B have low recovered revenue, which may indicate that similar products are rarely purchased when these shoes are out of stock. This may correspond to a high sensitivity to out of stock (e.g., not easily replaced). Thus, the client viewing the components 704A-B may prioritize having these shoes in stock. The pants, in another example, represented by the component 704C may include a high recovered revenue, indicating that users purchased a similar product often when the pants were out of stock. The modified lost revenue for the pants is two orders of magnitude lower than the revenue lost indicated by only considering the loss due to the pants being out of stock (e.g., ignoring the recovered revenue of purchases of a similar product). This may correspond to a low sensitivity to out of stock (e.g., easily replaced). Thus, the client viewing the component 704C may put the pants on a low priority for being in stock. The t-shirt represented by component 704D may have a sensitivity between the pants and the shoe, while the long-sleeve shirt represented by component 704E may have a sensitivity even higher than the shoes (e.g., almost irreplaceable, in terms of revenue, when out of stock).

A formula for sensitivity may include: Sensitivity equals one minus a number of sessions that have including a viewing of an out of stock product and where a similar product was purchased divided by a total number of sessions that include a viewing of the out of stock product, divided by a conversion rate. The formula may be simplified to sensitivity equals one minus similar product conversion rate divided by out of stock product conversion rate. A sensitivity of zero may mean that there was a higher chance of a user buying a similar product on a specific product page that is out of stock than of the user buying any product of the category when its product page is viewed (generally not out of stock).

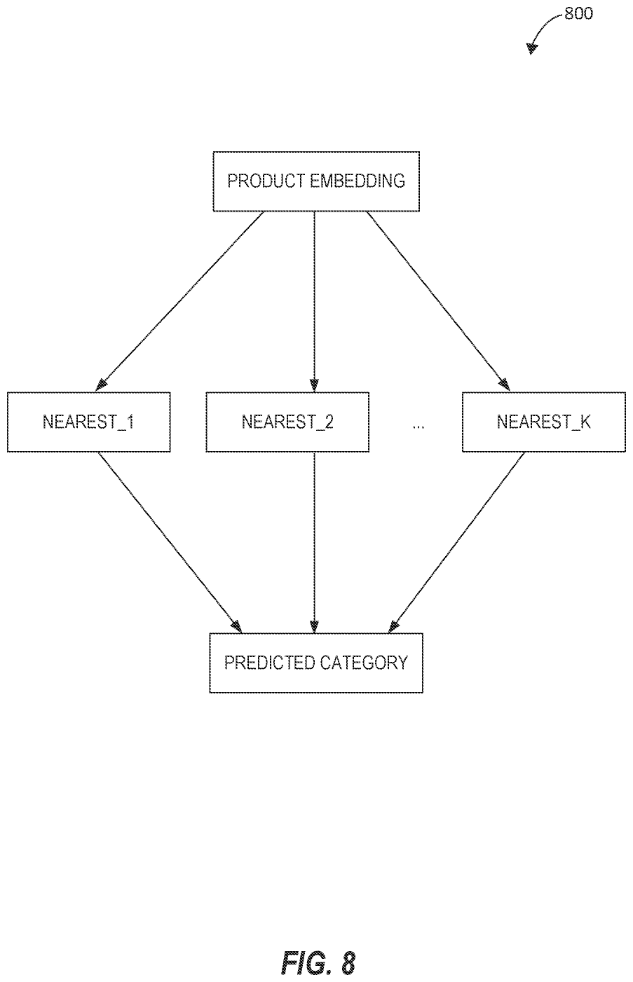

FIG. 8 illustrates a block diagram 800 for identifying a predicted category of similarity for products, in accordance with some examples. The block diagram 800 shows embedding extraction and category prediction for a product. The block diagram 800 may be used for computing a product embedding. Embeddings may include numerical descriptions or representations of text, an image, a string, etc.

Titles may be available and mostly unique in product catalogs, and product embeddings may be generated based on product titles, product image, reviews, user interactions, etc. Product embeddings may be extracted from titles using one or more of various algorithms, such as a fixed word-embedding dictionary, an encoder algorithm, natural language processing, a neural network technique, or the like. After mapping the titles to embedding space, the quality of this mapping may be evaluated to determine whether product embeddings in this new space are arranged in a meaningful or relevant way. One option or evaluation includes checking whether the embeddings are useful for a specified task. In an example, a task includes a product category prediction. If the embeddings are useful, products from the same or similar categories are close in that embedding space. In an example, category prediction may be used as a validation step. A ground truth product category may be identified from a product catalog. In an example, a k-nearest neighbor (kNN) classification in the embedding space may be used to check whether the predicted category matches the ground truth.

The block diagram 800 includes preprocessing, such as text processing to separate the words in the title and convert characters to lowercase. In some examples, the titles may be cleaned to remove nonalphabetic words, which may include specific codes for products. After preprocessing, the block diagram 800 includes extracting the embeddings. This may be achieved by processing titles per word or per sentence as a whole, in some examples. When processing titles per word, resulting embeddings may be aggregated by average pooling or by weighting them by their occurrence. The titles may be processed by frequency (e.g., by Inverse Document Frequency weights), by normalization step, or the like.

The block diagram 800 includes classification of the processed text. For example, classification may include a kNN classification. The kNN classifier may be used to predict categories of a product, for example the k most similar categories for a product (e.g., k=5, 10, etc.). To find a similar product, a nearest neighbors search may be used. In some examples, a distance metric may be used, such as a Euclidean distance.

The block diagram 800 may output a predicted category for a product. Predicting a category may be used to validate the embeddings. Similar products may be grouped in categories. When considering an out of stock item, the category of the out of stock item may be identified. Other products that are in the category may then be considered similar products.

Another way to generate a product embedding includes using user data. Looking at user sessions, patterns in how users interact with the products may be identified. For example, if two products are similar, it may be expected that users interact with them in the same way or in similar ways. This technique may avoid using catalog data, which may be outdated or difficult for the client to provide.

One potential issue to avoid with this technique includes avoiding bias or unexpected user behaviors. For example, a user may be assumed to rarely place two similar items in a cart, when usually only one is purchased. However, some users add to a cart as a buffer to compare items later and remove items before going to the checkout. When this behavior is statistically significant, artifacts in the resulting embeddings may be unexpected.

This technique may use sequences of product identifiers as input. There are different ways to generate these sequences that may result in different types of embeddings. For example, a sequence of product page views may be used. These embeddings may be similar for similar products as a customer often looks at multiple products before picking one to buy. In another example, a sequence of items added to cart may be used. These embeddings may be more suited for complementary products. In yet another example, final carts may be used with a random ordering, or an ordering coming from add to carts. In still another example, a sequence of product page views where the user interacted with products may be used.

A graph neural network (GNN) may be used to generate item embeddings. In some examples, a transformer may be used to take a sequence of embeddings and predict a next item. A model may be trained end to end on the recommendation task and the embeddings may be trained for this task as well. The embeddings may be extracted from the weights of the model. In some examples, the GNN may be applied on session graphs without a specific task. The way this algorithm trains may include minimizing the embeddings difference between neighbors.

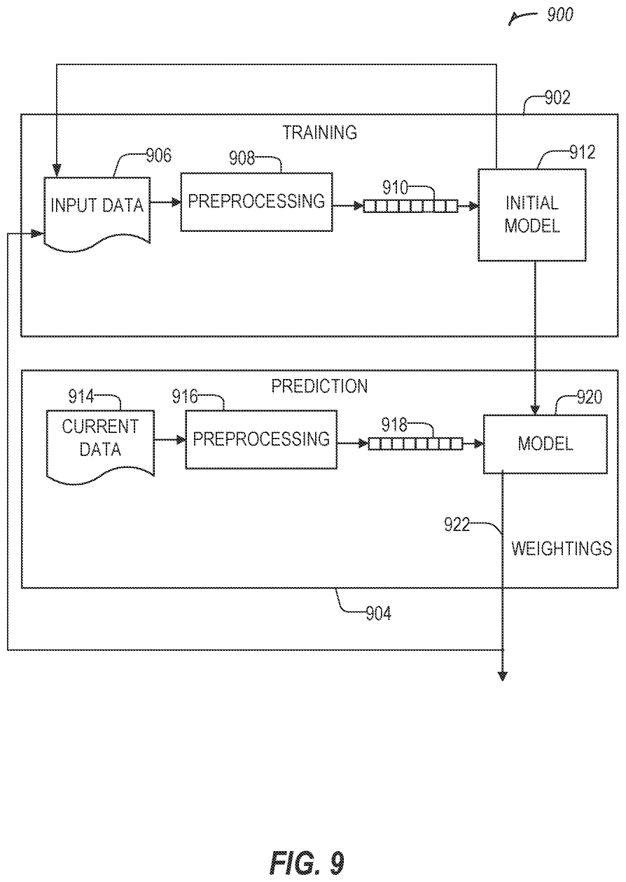

FIG. 9 illustrates a machine learning engine for training and execution related to identifying similar products in accordance with some embodiments. The machine learning engine can be deployed to execute at a mobile device (e.g., a cell phone) or a computer. A system may calculate one or more weightings for criteria based upon one or more machine learning algorithms. FIG. 9 shows an example machine learning engine 900 according to some examples of the present disclosure.

Machine learning engine 900 utilizes a training engine 902 and a prediction engine 904. Training engine 902 uses input data 906, after undergoing preprocessing component 908, to determine one or more features 910. The one or more features 910 may be used to generate an initial model 912, which may be updated iteratively or with future unlabeled data.

The input data 906 may include a product title, a product category, a product brand, a product description, a product review, a product image, a user's interaction with a product, such as a sequence of products added to cart, a sequence of product views, a transaction, or the like. In some examples, the input data 906 may include both product information and user interactions, for example, using a constructed Product Knowledge Graph. Labels for the input data may include similar products. In some cases, the input data may be unlabeled. The input data 906 may be generated from a source, such as one or more of a product catalogue, user transaction data, user interaction data (e.g., with a website), a revenue data report, or the like.

In the prediction engine 904, current data 914 may be input to preprocessing component 916. In some examples, preprocessing component 916 and preprocessing component 908 are the same. The prediction engine 904 produces feature vector 918 from the preprocessed current data, which is input into the model 920 to generate one or more criteria weightings 922. The criteria weightings 922 may be used to output a prediction, as discussed further below.

The training engine 902 may operate in an offline manner to train the model 920 (e.g., on a server). The prediction engine 904 may be designed to operate in an online manner (e.g., in real-time, at a mobile device, on an implant device, etc.). In other examples, the training engine 902 may operate in an online manner (e.g., at a mobile device). In some examples, the model 920 may be periodically updated via additional training (e.g., via updated input data 906 or based on labeled or unlabeled data output in the weightings 922) or client feedback (e.g., an update to a product catalogue, a website, a naming convention, an image or image set, etc.). The initial model 912 may be updated using further input data 906 until a satisfactory model 920 is generated. The model 920 generation may be stopped according to a specified criteria (e.g., after sufficient input data is used, such as 1,000, 10,000, 100,000 data points, etc.) or when data converges (e.g., similar inputs produce similar outputs).

The specific machine learning algorithm used for the training engine 902 may be selected from among many different potential supervised or unsupervised machine learning algorithms. Examples of supervised learning algorithms include artificial neural networks, Bayesian networks, instance-based learning, support vector machines, decision trees (e.g., Iterative Dichotomiser 3, C9.5, Classification and Regression Tree (CART), Chi-squared Automatic Interaction Detector (CHAID), and the like), random forests, linear classifiers, quadratic classifiers, k-nearest neighbor, linear regression, logistic regression, and hidden Markov models. Examples of unsupervised learning algorithms include expectation-maximization algorithms, vector quantization, and information bottleneck method. Unsupervised models may not have a training engine 902. In an example embodiment, a regression model is used and the model 920 is a vector of coefficients corresponding to a learned importance for each of the features in the vector of features 910, 918. Once trained, the model 920 may output one or more similar products to an identified product (e.g., an out of stock product).

### Glossary

“Carrier signal” refers to any intangible medium that is capable of storing, encoding, or carrying instructions for execution by the machine, and includes digital or analog communications signals or other intangible media to facilitate communication of such instructions. Instructions may be transmitted or received over a network using a transmission medium via a network interface device.

“Client device” refers to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application specific integrated circuit (ASIC). A hardware component may also include programmable logic or circuitry that is temporarily configured by software to perform certain operations. For example, a hardware component may include software executed by a general-purpose processor or other programmable processor. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors 1004 or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers to a tangible medium that is capable of storing, encoding, or carrying the instructions for execution by a machine.

“Signal medium” refers to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

Example 1 is a method of providing a conversion loss insight, the method comprising: collecting, at a server, pageviews for a plurality of users at a website; identifying an out of stock item that appeared in a subset of the pageviews during a time period; identifying, using a trained machine learning model, a similar product to the out of stock item; determining whether the similar product was purchased in respective sessions corresponding to pageviews of the subset of pageviews; and outputting an insight for display, the insight including information corresponding to a number of the respective sessions where the similar product was purchased.

In Example 2, the subject matter of Example 1 includes, retrieving a unit price of the out of stock item and a conversion rate corresponding to the out of stock item during the time period; determining, using a processor, a loss indicator corresponding to lost revenue due to the out of stock item based on the subset of the pageviews, the unit price, and the conversion rate; and wherein the insight includes information corresponding to the lost revenue.

In Example 3, the subject matter of Example 2 includes, wherein the insight includes a modified lost revenue based on a difference between the lost revenue and revenue generated from the respective sessions where the similar product was purchased.

In Example 4, the subject matter of Examples 2-3 includes, wherein the modified lost revenue includes an adjustment for a price difference between the out of stock item and the similar product.

In Example 5, the subject matter of Examples 1-4 includes, wherein identifying the similar product includes identifying, using the trained machine learning model, a plurality of similar products to the out of stock item, and wherein the insight includes information corresponding to a number of the respective sessions where any of the plurality of similar products were purchased.

In Example 6, the subject matter of Examples 1-5 includes, wherein trained machine learning model is trained using at least one of product titles, product categories, product brands, product descriptions, product reviews, or product images.

In Example 7, the subject matter of Examples 1-6 includes, wherein the trained machine learning model is trained based on user interactions in training sessions, including at least one of sequences of products added to a card, sequences of product views, or transactions.

In Example 8, the subject matter of Examples 1-7 includes, wherein identifying the similar product includes using a distance calculation between an embedding corresponding to the out of stock item and an embedding corresponding to a prospective similar product.

In Example 9, the subject matter of Examples 1-8 includes, wherein outputting the insight for display includes outputting a sensitivity score, the sensitivity score identifying a likelihood of the similar product being purchased when the out of stock item is out of stock.

Example 10 is a computing apparatus, the computing apparatus comprising: a processor; and a memory storing instructions that, when executed by the processor, configure the apparatus to: collect pageviews for a plurality of users at a website; identify an out of stock item that appeared in a subset of the pageviews during a time period; identify, using a trained machine learning model, a similar product to the out of stock item; determine whether the similar product was purchased in respective sessions corresponding to pageviews of the subset of pageviews; and output an insight for display, the insight including information corresponding to a number of the respective sessions where the similar product was purchased.

In Example 11, the subject matter of Example 10 includes, wherein the instructions, when executed by the processor, further configure the apparatus to: retrieve a unit price of the out of stock item and a conversion rate corresponding to the out of stock item during the time period; determine, using a processor, a loss indicator corresponding to lost revenue due to the out of stock item based on the subset of the pageviews, the unit price, and the conversion rate; and wherein the insight includes information corresponding to the lost revenue.

In Example 12, the subject matter of Example 11 includes, wherein the insight includes a modified lost revenue based on a difference between the lost revenue and revenue generated from the respective sessions where the similar product was purchased.

In Example 13, the subject matter of Examples 11-12 includes, wherein the modified lost revenue includes an adjustment for a price difference between the out of stock item and the similar product.

In Example 14, the subject matter of Examples 10-13 includes, wherein to identify the similar product, the instructions, when executed by the processor, further configure the apparatus to identify, using the trained machine learning model, a plurality of similar products to the out of stock item, and wherein the insight includes information corresponding to a number of the respective sessions where any of the plurality of similar products were purchased.

In Example 15, the subject matter of Examples 10-14 includes, wherein trained machine learning model is trained using at least one of product titles, product categories, product brands, product descriptions, product reviews, or product images.

In Example 16, the subject matter of Examples 10-15 includes, wherein the trained machine learning model is trained based on user interactions in training sessions, including at least one of sequences of products added to a card, sequences of product views, or transactions.

In Example 17, the subject matter of Examples 10-16 includes, wherein to identify the similar product, the instructions, when executed by the processor, further configure the apparatus to use a distance calculation between an embedding corresponding to the out of stock item and an embedding corresponding to a prospective similar product.

In Example 18, the subject matter of Examples 10-17 includes, wherein to output the insight for display, the instructions, when executed by the processor, further configure the apparatus to output a sensitivity score, the sensitivity score identifying a likelihood of the similar product being purchased when the out of stock item is out of stock.

Example 19 is at least one non-transitory machine-readable medium including instructions, which when executed by processing circuitry, causes the processing circuitry to perform operations to: collect pageviews for a plurality of users at a website; identify an out of stock item that appeared in a subset of the pageviews during a time period; identify, using a trained machine learning model, a similar product to the out of stock item; determine whether the similar product was purchased in respective sessions corresponding to pageviews of the subset of pageviews; and output an insight for display, the insight including information corresponding to a number of the respective sessions where the similar product was purchased.

In Example 20, the subject matter of Example 19 includes, wherein trained machine learning model is trained using at least one of product titles, product categories, product brands, product descriptions, product reviews, product images, or user interactions in training sessions.

Example 21 is at least one machine-readable medium including instructions that, when executed by processing circuitry, cause the processing circuitry to perform operations to implement of any of Examples 1-20.

Example 22 is an apparatus comprising means to implement of any of Examples 1-20.

Example 23 is a system to implement of any of Examples 1-20.

Example 24 is a method to implement of any of Examples 1-20.

1. A method of providing a conversion loss insight, the method comprising:
collecting, at a server, pageviews for a plurality of users at a website;
identifying an out of stock item that appeared in a subset of the pageviews during a time period;
identifying, using a trained machine learning model, a similar product to the out of stock item, the trained machine learning model trained using sequences of product identifiers based on product page views to output similar products;
determining whether the similar product was purchased in respective sessions corresponding to pageviews of the subset of pageviews;
determining, from the determination of whether the similar product was purchased in the respective sessions, a replaceability score for the out of stock item, the replaceability score indicating how replaceable the out of stock item is with respect to revenue lost due to the out of stock item being out of stock;
outputting the replaceability score and an insight for display, the insight including information corresponding to a number of the respective sessions where the similar product was purchased; and
using the replaceability score to update, via additional training, the trained machine learning model.

2. The method of claim 1, further comprising:
retrieving a unit price of the out of stock item and a conversion rate corresponding to the out of stock item during the time period;
determining, using a processor, a loss indicator corresponding to lost revenue due to the out of stock item based on the subset of the pageviews, the unit price, and the conversion rate; and
wherein the insight includes information corresponding to the lost revenue.

3. The method of claim 2, wherein the insight includes a modified lost revenue based on a difference between the lost revenue and revenue generated from the respective sessions where the similar product was purchased.

4. The method of claim 2, wherein the modified lost revenue includes an adjustment for a price difference between the out of stock item and the similar product.

5. The method of claim 1, wherein identifying the similar product includes identifying, using the trained machine learning model, a plurality of similar products to the out of stock item, and wherein the insight includes information corresponding to a number of the respective sessions where any of the plurality of similar products were purchased.

6. The method of claim 1, wherein trained machine learning model is trained using at least one of product titles, product categories, product brands, product descriptions, product reviews, or product images.

7. The method of claim 1, wherein the trained machine learning model is trained based on user interactions in training sessions, including at least one of sequences of products added to a card, sequences of product views, or transactions.

8. The method of claim 1, wherein identifying the similar product includes using a distance calculation between an embedding corresponding to the out of stock item and an embedding corresponding to a prospective similar product.

9. The method of claim 1, wherein outputting the insight for display includes outputting a sensitivity score, the sensitivity score identifying a likelihood of the similar product being purchased when the out of stock item is out of stock.

10. A computing apparatus, the computing apparatus comprising:
a processor; and
a memory storing instructions that, when executed by the processor, configure the apparatus to:
collect pageviews for a plurality of users at a website;
identify an out of stock item that appeared in a subset of the pageviews during a time period;
identify, using a trained machine learning model, a similar product to the out of stock item, the trained machine learning model trained using sequences of product identifiers based on product page views to output similar products;
determine whether the similar product was purchased in respective sessions corresponding to pageviews of the subset of pageviews;
determine, from the determination of whether the similar product was purchased in the respective sessions, a replaceability score for the out of stock item, the replaceability score indicating how replaceable the out of stock item is with respect to revenue lost due to the out of stock item being out of stock;
output the replaceability score and an insight for display, the insight including information corresponding to a number of the respective sessions where the similar product was purchased; and
use the replaceability score to update, via additional training, the trained machine learning model.

11. The computing apparatus of claim 10, wherein the instructions, when executed by the processor, further configure the apparatus to:
retrieve a unit price of the out of stock item and a conversion rate corresponding to the out of stock item during the time period;
determine, using a processor, a loss indicator corresponding to lost revenue due to the out of stock item based on the subset of the pageviews, the unit price, and the conversion rate; and
wherein the insight includes information corresponding to the lost revenue.

12. The computing apparatus of claim 11, wherein the insight includes a modified lost revenue based on a difference between the lost revenue and revenue generated from the respective sessions where the similar product was purchased.

13. The computing apparatus of claim 11, wherein the modified lost revenue includes an adjustment for a price difference between the out of stock item and the similar product.

14. The computing apparatus of claim 10, wherein to identify the similar product, the instructions, when executed by the processor, further configure the apparatus to identify, using the trained machine learning model, a plurality of similar products to the out of stock item, and wherein the insight includes information corresponding to a number of the respective sessions where any of the plurality of similar products were purchased.

15. The computing apparatus of claim 10, wherein trained machine learning model is trained using at least one of product titles, product categories, product brands, product descriptions, product reviews, or product images.

16. The computing apparatus of claim 10, wherein the trained machine learning model is trained based on user interactions in training sessions, including at least one of sequences of products added to a card, sequences of product views, or transactions.

17. The computing apparatus of claim 10, wherein to identify the similar product, the instructions, when executed by the processor, further configure the apparatus to use a distance calculation between an embedding corresponding to the out of stock item and an embedding corresponding to a prospective similar product.

18. The computing apparatus of claim 10, wherein to output the insight for display, the instructions, when executed by the processor, further configure the apparatus to output a sensitivity score, the sensitivity score identifying a likelihood of the similar product being purchased when the out of stock item is out of stock.

19. At least one non-transitory machine-readable medium including instructions, which when executed by processing circuitry, causes the processing circuitry to perform operations to:
collect pageviews for a plurality of users at a website;
identify an out of stock item that appeared in a subset of the pageviews during a time period;
identify, using a trained machine learning model, a similar product to the out of stock item, the trained machine learning model trained using sequences of product identifiers based on product page views to output similar products;
determine whether the similar product was purchased in respective sessions corresponding to pageviews of the subset of pageviews;
determine, from the determination of whether the similar product was purchased in the respective sessions, a replaceability score for the out of stock item, the replaceability score indicating how replaceable the out of stock item is with respect to revenue lost due to the out of stock item being out of stock;
output the replaceability score and an insight for display, the insight including information corresponding to a number of the respective sessions where the similar product was purchased; and
use the replaceability score to update, via additional training, the trained machine learning model.

20. The at least one machine-readable medium of claim 19, wherein trained machine learning model is trained using at least one of product titles, product categories, product brands, product descriptions, product reviews, product images, or user interactions in training sessions.
